(19) United States
(12) Patent Application Publication
(10) Pub. No.: US 2006/0166722 A1
(43) Pub. Date: Jul. 27, 2006

(54) Mobile phone back clip device

(75) Inventor: Huasheng Gu, Hangzhou (CN)

Correspondence Address: BLANK ROME LLP, 600 NEW HAMPSHIRE AVENUE, N.W., WASHINGTON, DC, 20037, US

(73) Assignee: AMPHENOL HANGZHOU PHOENIX TELECOM PARTS CO., LTD., Hangzhou (CN)

(21) Appl. No.: 11/257,000

(22) Filed: Oct. 25, 2005

(30) Foreign Application Priority Data
Jan. 26, 2005 (CN) 200520100310.7

(51) Int. Cl. H04M 1/00

(52) U.S. Cl. 455/575.8

(57) ABSTRACT

The utility model provides a mobile phone back clip device comprising a casing and a clip at the back of the casing, the clip is rotatablely connected with the casing, and the back clip device is also provided with a fixing structure for keeping a rotation angle of the casing relative to the clip and another fixing structure for keeping the axial positioning relation of the clip and the casing relative to a rotation shaft. The utility model allows the casing to be rotatable under the action of external force and to be selectively fixed at a plurality of rotation angles according to arrangement condition of the fixing structure so that the mobile phone can be carried according to different postures and habits and people can carry mobile phones conveniently and comfortably.

### TECHNICAL FIELD

The present utility model relates to a mobile phone accessory, and more particularly to a mobile phone back clip device for carrying a mobile phone.

### BACKGROUND OF THE INVENTION

With the development of technology, mobile phones are popular with thousands of families and become means of communication indispensable to people. But mobile phone users are often puzzled by their carrying manners, some use a pocket to accommodate the mobile phone and hang it around the neck, some put the mobile phone in a mobile phone jacket, and also some use a back clip type mobile phone holder comprising a casing convenient for mobile phone to be pushed in or drawn out and matching with the mobile phone body, and a clip firmly connected with clothes is secured at the back of the casing. A mobile phone back clip is generally clipped to a belt by a clip, then the mobile phone is enclosed in the casing. The disadvantage of the mobile phone back clip having this structure lies in that, because the clip is fixedly connected with the casing, the direction and position of the mobile phone are relatively fixed during carrying, sometimes postural problem can cause uncomfortable or inconvenient feeling.

### SUMMARY OF THE INVENTION

The technical problem to be solved by the present utility model is to provide a mobile phone back clip device capable of changing carrying direction adapted to different carrying manners. The aim of the utility model is achieved by that, the back clip comprises a casing and a clip at the back of the casing, the clip is rotatablely connected with the casing, the back clip is also provided with a fixing structure for keeping casing rotation angle relative to the clip and a fixing structure keeping axial fixing relation of the clip and the casing relative to a rotation shaft. The casing in accordance with the utility model generally refers to a component capable of storing a mobile phone including a covered casing or a lidless casing capable of fixing the mobile phone therein and including a hard casing made of plastic material or a soft casing made of leather material.

The structure provided by the utility model allows the casing to be rotatable under the action of external force and to be selectively fixed at a plurality of rotation angles according to arrangement condition of the fixing structure so that the mobile phone can be carried according to different postures and habits and people can carry mobile phones conveniently and comfortably.

### BRIEF DESCRIPTION OF THE FIGURES

FIG. 1 is a sectional view of embodiment 1 of the present utility model.

FIG. 2 is an abridged general view of rotation connection and fixing structure in the embodiment 1.

FIG. 3 is a sectional view of embodiment 2 of the present utility model.

FIG. 4 is an abridged general view of a casing portion in the embodiment 2.

FIG. 5 is an abridged general view of a connection strap portion in the embodiment 2.

FIG. 6 is an exploded abridged general view of embodiment 3 of the present utility model.

FIG. 7 is an axially exploded bridged general view of embodiment 4 of the present utility model.

FIG. 8 is an abridged general view of surface of the casing. which is used to fit the connection strap.

FIG. 9 is an abridged general view of surface of the connection strap which is used to fit the casing.

FIG. 10 is an abridged general left-view of the axial limitation element.

### DETAILED DESCRIPTION OF THE INVENTION

### Embodiment 1

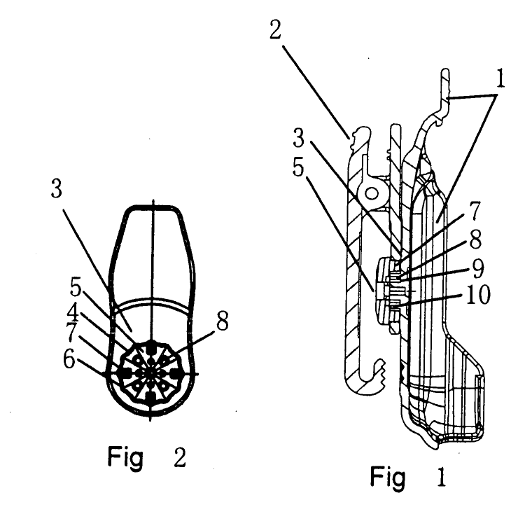

Refering to FIGS. 1 and 2. The mobile phone back clip device provided by the present utility model comprises a casing 1 and a clip 2 at the back of the casing, the clip is rotatablely connected with the casing, and it is provided with a fixing structure for keeping a rotation angle of the casing relative to the clip and another fixing structure for keeping the axial positioning relation of the clip and the casing relative to a rotation shaft.

The rotation shaft can be fixedly connected with the casing, and the fixed connection can be understood as the rotation shaft is directly formed on the casing or as the rotation shaft is fixedly mounted on the casing.

In this embodiment, the rotation shaft 10 is directly formed on the casing, a positioning element 5 with a plurality of peripheral projections 7 is fixedly enclosed on the rotation shaft, the clip is provided with a connection strap 3 rotatablely enclosed on the positioning element and axially fastened or clipped at the back of the casing by the positioning element. There should be reasonable clearance between parts in the clipping or fastening cooperating structure thus enabling the casing to be rotatable. A plurality of grooves 6 cooperating with projections or grooves on the positioning element are arranged on hole 4 surface of the connection strap. Relatively speaking, the structure is simpler and suitable for assembling.

Apparently, the projections 7 can be changed to grooves, and grooves 6 can be changed into projections. For the connection strap, it can be part of the clip itself and also can be an additional element on the clip.

The grooves or projections on the connection strap can be directly formed around the hole. Certainly, the grooves or projections of the connection strap also can be arranged on an insert connected to the hole.

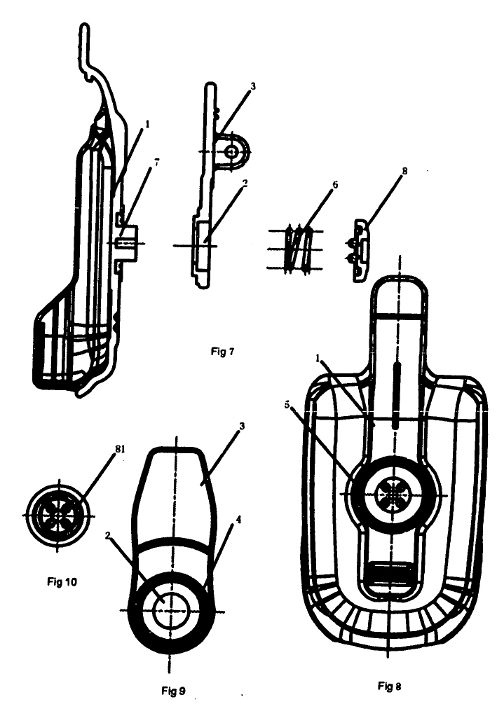

FIGS. 8 and 9 are a pin and a socket respectively arranged on the rotation shaft and a mounting seat for preventing unexpected relative rotation between the rotation shaft and the positioning element 5. In mounting, a screw connected with the rotation shaft is screwed in the center of the positioning element.

As shown in FIG. 2, four projections 7 are uniformly arranged along the circumference, and twelve grooves 6 are uniformly arranged along the circumference. The number of projections 7 can be anyone not more than the number of grooves 6, as long as every projection 7 can drop into the grooves at each fixing position after rotation.

During the use of the mobile phone back clip device, when the casing is subjected to definite external force action, the projections 6 leave the current grooves, and the casing is allowed to rotate. When the casing rotates to a appropriate rotation angle, external force is released and the projections 6 drop into corresponding grooves. Here, projections 6 serve as fixing seats relative to the grooves. In this way, the casing can be kept stable at the rotation angle by cooperation of grooves and projections.

### Embodiment 2

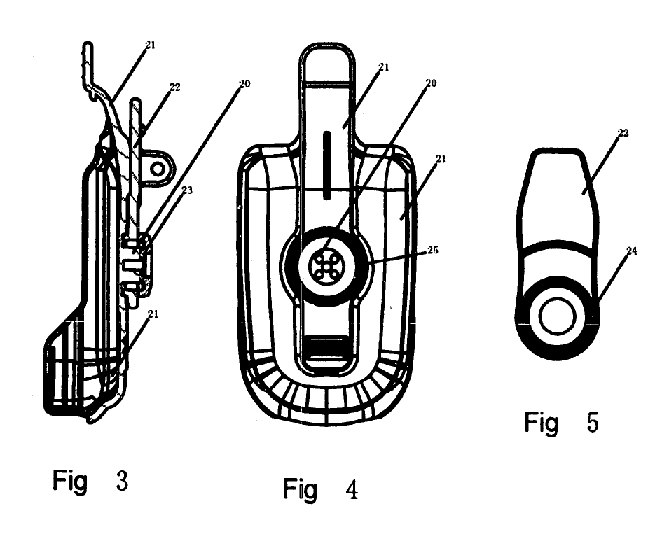

Refering to FIGS. 3, 4 and 5. In this embodiment, a rotation shaft 20 is fixedly connected with a casing 21. Similarly, the fixed connection can be understood as the rotation shaft is directly formed on the casing and can also be understood as the rotation shaft is fixedly mounted on the casing.

As shown in the figures, the rotation shaft is directly formed on the casing, and on the clip is arranged a connection strap 22 rotatablely connected on the rotation shaft. The mobile phone back clip device is also provided with a connection strap axial limitation element 23 connected with the rotation shaft so that the connection strap is axially fastened or clipped on the rotation shaft by the axial limitation element 23. A plurality of projections or grooves are arranged on the connection strap surface along rotation direction of the rotation shaft, and a plurality of grooves or projections cooperating with projections or grooves of the connection strap are arranged on casing portion facing the connection strap or portion fixedly connected with the casing and facing the connection strap.

A plurality of projections or grooves arranged on the connection strap surface along rotation direction of the rotation shaft are radial serrations 24, accordingly, a plurality of grooves or projections arranged on casing portion facing the connection strap or portion fixedly connected with the casing and facing the connection strap are serrations 25 engaged with the radial serrations.

### Embodiment 3

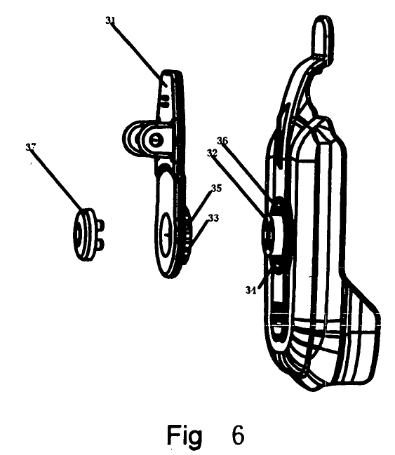

Refering to FIG. 6. In this embodiment, a connection strap 31 is arranged on the clip. A rotation shaft 32 is fixedly connected with the casing, and the fixed connection can be understood as the rotation shaft is directly formed on the casing and can also be understood as the rotation shaft is fixedly mounted on the casing. A pillow block 33 is arranged on the connection strap, and a shaft hole 34 for enabling the pillow block to insert is arranged on the casing. The pillow block is rotatablely inserted between the rotation shaft and the shaft hole. A plurality of projections 35 are arranged around the pillow block, and a plurality of grooves or projections 36 cooperating with projections or grooves of the pillow block are arranged on the shaft hole of the casing. Such fixing and cooperating relations for grooves and projections are similar to embodiment 1. The mobile phone back clip device is also provided with a connection strap axial limitation element 37 through the pillow block and connected with the casing. In this way, the connection strap is axially fastened or clipped on the rotation shaft.

### Embodiment 4

Referring to FIGS. 7, 8, 9, and 10. The mobile phone back clip device provided by the present utility model comprises a casing 41 and a clip at the back of the casing. The rotation shaft is fixedly connected with the casing. The clip is provided with a connection strap 43 rotatablely connected on the rotation shaft 47. A plurality of projections or grooves 44 are arranged on the surface of the connection strap along the rotation direction of the rotation shaft, and a plurality of grooves or projections 45 cooperating with the projections or grooves of the connection strap are arranged on the casing portion facing the connection strap or portion fixedly connected with the casing and facing the connection strap. The mobile phone back clip device is also provided with a spring 46 for axially tightening the mating part of the connection strap with the casing and a connection strap axial limitation element 48 connected with the rotation shaft. The spring is arranged between the axial limitation element and the connection strap.

A plurality of projections or grooves arranged on the surface of the connection strap along the rotation direction of the rotation shaft are radial serrations 44, accordingly, a plurality of grooves or projections arranged on casing portion facing the connection strap or portion fixedly connected with the casing and facing the connection strap are serrations 45 engaged with the radial serrations.

Alternatively, other suitable shapes may be employed for the projections and the grooves. Preferably, the projections and the grooves have mating inclined planes for compressing the spring 46 by the interaction between the projections and the grooves.

During the use of the mobile phone back clip device, when the casing is subjected to a definite external force action, because of the interaction between the serrations 44 and 45, the spring 46 is compressed. The serrations 44 and 45 are released from the initial engagement state, relative rotation between the casing and the clip is made possible, and the serrations 45 slip over the serrations 44 tooth by tooth. When the casing rotates to a appropriate carrying angle, the external force is released, the serrations 44 and 45 are engaged again because of tightening action of the elastic element, and consequently the casing can be kept stable at this rotation angle. The other effect obtained by the structure lies in that the spring compression and recovery causes axial relative displacement between the connection strap and the casing. In this way, material requirement (such as wear resistant requirement or deformation and recovery of material) to the mating part of the casing with the connection strap can be lowered, and the manufacturing cost can be lowered.

The rotation connection shaft 47 is fixedly connected with the casing, there are some ways to fix the shaft 47 to the casing. for example, merging shaft 7 with the casing, connecting them together by some connect-elements, or tight fitting them. and the connection strap is rotatablely connected on the rotation shaft 47. The label 42 stands for the hole enclosed on the rotation shaft on the connection strap, as shown in FIG. 10, and label 481 represents an annular seat for the positioning spring.

Alternatively, the shaft 47 can also be an independent element mounted on the casing by a mounting piece. In this case, the shaft 47 can also be provided with a configuration for positioning the connection strap 43. Therefore, the spring is arranged between the positioning configuration and the connection strap. In addition, the shaft 47 can also be connected or formed together with the connection strap, and the spring can be replaced by other elements that can be compressed and rebounded, such as a spring leaf, etc.

Spring can be replaced by other elements which can be compressed and rebounded like spring leaf or elastic spacer which fixed between the axial limitation element and the connection strap.

In fact, the utility model may adopt various other form of rotating and fixing structures, for example, the casing can be located at a rotatable position or a non-rotatable position by axial drawing, and the casing can be translatable and fixed axially by a spring. Or alternatively, the axis in the embodiments is arranged on the connection strap, and the connection strap structure in the embodiments is arranged on the casing.

The utility model is further illustrated by the above embodiments. The embodiments are provided with an aim that people can understand the utility model more easily. The embodiments should not be understood as limitation to the scope of the utility model to be protected.

1. A mobile phone back clip device, comprising a casing and a clip arranged at the back of the casing, wherein said clip and casing are rotatablely connected, the back clip device is also provided with a fixing structure for keeping a rotation angle of the casing relative to the clip, and another fixing structure for keeping the axial positioning relation of the clip and the casing relative to a rotation shaft.

2. The mobile phone back clip device of claim 1, further comprising a rotation shaft fixedly connected with the casing; a positioning element, with a plurality of peripheral projections or grooves, fixedly enclosed on the rotation shaft; and a connection strap, provided with the clip, rotatablely enclosed on the positioning element and axially fastened or clipped at the back of the casing by the positioning element, the connection strap contains a plurality of grooves or projections, cooperating with the projections or grooves on the positioning element arranged, on the surface of a hole on the connection strap.

3. The casing back clip device of claim 2, wherein said grooves or projections are directly formed on the periphery of the hole on the connection strap.

4. The mobile phone back clip device of claim 2, wherein an insert provided to connect with the hole on the connection strap, said groovese or projections on the surface of the hole being arranged on the insert.

5. The mobile phone back clip device of claim 1, further comprising a rotation shaft fixedly connected with the casing; a connection strap, provided with the clip, rotatablely connected on the rotation shaft and axially fastened or clipped on the rotation shaft; a plurality of projections or grooves arranged on the connection strap surface along the rotation direction of the rotation shaft; and a plurality of grooves or projections, cooperating with the projections or grooves of the connection strap, arranged on the casing portion facing the connection strap or portion fixedly connected with the casing and facing the connection strap.

6. The mobile phone back clip device of claim 1, further comprising a rotation shaft is fixedly connected with the casing; a connection strap, provided with the clip, rotatablely connected on the rotation shaft; a plurality of projections or grooves arranged on the surface of the connection strap along the rotation direction of the rotation shaft; and a plurality of grooves or projections, cooperating with the projections or grooves of the connection strap, arranged on the casing portion facing the connection strap or portion fixedly connected with the casing and facing the connection strap; a spring for axially tightening connection strap with the casing; and a connection strap axial limitation element connected with the rotation shaft; the spring is arranged between the axial limitation element and the connection strap.

7. The mobile phone back clip device of claim 5, wherein the multiple projections or grooves arranged on the connection strap surface along rotation direction of the rotation shaft are radial serrations and the grooves or projections arranged on the casing portion facing the connection strap or portion fixedly connected with the casing and facing the connection strap are serrations engaged with said radial serrations.

8. The mobile phone back clip device of claim 1, further comprising a connection strap is arranged on the clip; a rotation shaft fixedly connected with the casing; a pillow block arranged on the connection strap; and a shaft hole for inserting the pillow block arranged on the casing, the pillow block with a plurality of peripheral projections or grooves is rotatablely inserted between the rotation shaft and the shaft hole, a plurality of grooves or projections cooperating with projections or grooves of the pillow block are arranged on the shaft hole of the casing, the connection strap is axially fastened or clipped onto the rotation shaft.

9. The mobile phone back clip device of claim 5, wherein the rotation shaft is formed on the casing, and connected with a connection strap axial limitation element.
